(19) United States
(12) Patent Application Publication
(10) Pub. No.: US 2010/0233657 A1
(43) Pub. Date: Sep. 16, 2010

(54) JAW IMPLANT AND METHOD FOR PRODUCING A SCREW-SHAPED RECESS IN THE JAW BONE FOR RECEIVING A SCREW-SHAPED ANCHORING PART OF A JAW IMPLANT

(76) Inventor: Gernot Teichmann, Bern (CH)

Correspondence Address: MATTHIAS SCHOLL, 14781 MEMORIAL DRIVE, SUITE 1319, HOUSTON, TX, 77079, US

(21) Appl. No.: 12/293,808

(22) PCT Filed: Aug. 21, 2007
(86) PCT No.: PCT/DE2007/001476

§ 371 Date: Sep. 19, 2008

(30) Foreign Application Priority Data
Aug. 21, 2006 (DE) 10 2006 039 116.0
Mar. 1, 2007 (DE) 10 2007 009 935.7

(51) Int. Cl. A61C 8/00

(52) U.S. Cl. 433/174; 433/215

(57) ABSTRACT

In a jaw implant, an anchoring part (1) is designed in the manner of a helix (3), in which the size ratio of external diameter (Da) to core diameter (Di) is equal to or greater than 2. The invention also proposes a two-step method, and a device for carrying out the method using a special tool, in order to produce a helical recess in the jaw bone into which the anchoring part (1) can be screwed.

The invention first of all relates to a jaw implant having an anchoring part which is in the form of a screw and comprises a core and at least one thread pitch which is integrally formed radially on the core.

Jaw implants such as these, also referred to as dental implants, are already known in various forms. The known dental implants in principle act like a screw in the area of the anchorage, and may even be formed with self-tapping threads. Similar to standard screws, they always have a relatively thick core and a plurality of thread pitches with a relatively shallow depth.

EP 1609436 A1 discloses an anchoring part which is rounded at the lower end but is otherwise continuously cylindrical, with thread pitches similar to a round thread. EP 1502558 A1 discloses an anchoring part having a V-shaped thread with an angle of about 70°, and blades integrally formed at the lower end, similar to a tap. EP 1563802 A1 discloses a conical anchoring part having a V-shaped thread with an angle of about 30° and a constant thread depth. A blade is integrally formed on the conical core at the lower end. EP 1527749 A1 discloses a slightly conical anchoring part which has a sawtooth thread with an angle of about 40°, and a thread depth which increases downwards, that is to say with a conical core.

The size ratio of the external diameter to the core diameter of the thread in the prior art is about 1.2 to 1.8, with the greater values being achieved only in the case of conical embodiments, in the lower tip area. The lower values, in contrast, are, for example, in the standard range for normal screws. The thread pitches are thus relatively compact, that is to say they have a shallow depth or height.

The already known jaw implants with anchoring parts in the form of screws are intended to be screwed into a hole which has been introduced into the jaw bone from the mouth cavity. The screwed-in jaw implant is used to hold a crown or bridge or to support a prosthesis or partial prosthesis. On the one hand, the already known jaw implants require a certain minimum length of the anchoring part, and therefore of the thread, in order to anchor them securely, which thread, for example, may comprise 7 to 22 thread turns, for example in the case of the aforementioned prior art, in order to make it possible to transmit the chewing forces which act on the tooth or the like reliably to the jaw bone over a long time. On the other hand, the previous jaw implants in the form of screws lead, because of the geometric design of the thread as explained above, to considerable radial support, but only to a small amount of axial support, for the implant in the jaw bone. This can lead to the implant becoming loose over the useful life of the implant, that is to say loosening of the firm connection between the anchoring part and the jaw bone.

Against the background of the described circumstances, the invention is in general based on the aim of designing a jaw implant of this generic type such that the connection between its anchoring part and the jaw bone is ensured over a long time.

In order to achieve this, the invention proposes that the anchoring part be in the form of a worm in which the size ratio of the external diameter to the core diameter is equal to or greater than 2.

In principle, the invention therefore departs from the design of the anchoring part in the form of a screw thread of the known type, irrespective of whether this or its core is straight or conical. In fact, it is now proposed that the previous thread depth be increased considerably in comparison to the core diameter, to be precise to such an extent that this is now no longer a thread but virtually a worm. This new design leads to considerably greater axial support and connection of the anchoring part to the jaw bone, so that it can be expected that the implant will be anchored well in the jaw bone over a long time, once the anchoring part has been introduced into a complementary opening in the jaw bone. The dimensions of this opening should therefore be matched accurately to the anchoring part, for example in the form of a slight interference fit, so that, when the worm is screwed in, the spongy jaw bone is slightly compressed axially by the very flat turns.

This new form also means that the implant with the core which projects out of the bone and has a small diameter offers only a small area for infections to attack, in contrast to the relatively thick implants, which project out of the bone, according to the prior art.

The said size ratio may be between 2 and 5, depending on how much space is available in the jaw bone in the respective individual case.

In order to introduce the anchoring part into the opening with virtually no gaps, it is also possible to provide for the worm thread to change, at the lower end over an at least approximately radial curve, from the external diameter to the core diameter.

In order to assist the screwing-in process without any gaps, a form is also useful in which the core has a circular-cylindrical cross section and has a section which is rounded at the end and projects somewhat out of the worm at the bottom.

The external diameter of the anchoring part can remain at least essentially constant over the length of the worm thread. The worm thread per se may have different cross-sectional shapes: in principle, for example, it may be in the form of a V-shaped thread, a trapezoidal thread or a sawtooth thread, which is in each case very flat, in which case the outer tip or outer edge of the worm thread should be at least slightly rounded. The very flat, thin form of the worm thread in this case results in a very small tip angle of about 10° to 20° in the case of a V-shaped or sawtooth thread, in comparison to conventional threads.

In order to provide the anchoring part including the worm with a certain amount of robustness, the inner thickness of the worm thread should be about 0.5 to 2.0 mm, and the outer thickness of the worm thread should be at most 1.0 mm.

If the bone mass is adequate, as is the case for example in the lower jaw, it is possible for the worm thread to cover one entire revolution, two revolutions or even more.

When a long implant in the form of a screw and according to the prior art is being anchored in a relatively thin bone layer or remaining bone layer, the length of the screw thread can result in difficulties: for example, the bone layer in the area of the upper jaw molar teeth is relatively thin, because of the extent of the maxillary sinus. Until now, it has therefore been necessary to operatively reduce the size of the maxillary sinus in order to allow the space obtained to be filled with real or artificial bone in order in this way to create an adequately thick bone layer to hold the anchoring part which is in the form of a screw. This operation, which is known in the specialist field as sinus lift, causes additional stress to the patient and in general increases the risk of failure of a jaw implant.

The invention offers a major advantage here: the anchoring part can be kept extremely short in a situation such as this because the worm thread covers only two, one or even only a fraction of one revolution. Although a single-thread worm is also often adequate, the worm may nevertheless be formed with two or more threads in order to enlarge the anchorage areas. In the extreme, the worm may have two threads, with both worm threads having just two diametrically opposite partial worm threads, thus resulting in the shape of a two-bladed propeller. In this form, the anchoring part can be screwed into a relatively thin and even very narrow bone layer with a fraction of one revolution. There is no need for an operation as explained above, therefore likewise avoiding the risk associated with this. In addition, the patient is protected, and time and costs are saved.

The dimensions of the worm must be matched to the requirements of the respective individual case. Since, in principle, a normal attachment hole requires a certain amount of space in the core, the core diameter may be approximately 2 to 5 mm, with a small core diameter of for example 3 to 4 mm being preferred for the stated reasons.

In order to allow the jaw bone to grow well into the anchoring part, it is possible to provide for at least one worm thread or partial worm thread to be provided with at least one recess, but preferably with a plurality of recesses. A recess such as this can easily be shaped like a blind hole, or can pass axially through the worm thread, and/or can be formed to be somewhat open, for example, radially, that is to say at the side.

The invention also relates to a method for production of a recess, in the form of a screw, in the jaw bone in order to hold an anchoring part, in the form of a screw, of a jaw implant. Until now, the relatively long recesses in the form of screws have been produced either by means of a hole, a tap or by means of a self-tapping anchoring part. This had led to the disadvantages already described above. In particular, if the anchoring part is designed according to the invention as a worm having appropriate diameters, then, in a first step, a cylindrical hole can be introduced into the jaw bone and, in a second step, at least one recess, which is at least in the form of a partial helix and is in the form of a worm, can be introduced around the cylindrical hole.

The required spaces in the jaw bone, that is to say the cylindrical recess and the recess which is in the form of a worm and is at least partially helical, can be introduced per se using an expedient method, largely any desired method, but preferably by means of a material-removing tool. In order to carry out the second step in particular, it is proposed that a helical movement be applied to the tool. This movement results in the tool producing the recess in the form of a worm in the jaw bone. In addition, it is possible to provide for the movement direction of the tool to be reversed at short intervals, and then continued, during the helical movement. This results, for example, in a type of chiseling or hammering in the helical direction, and a mechanical tool cannot become stuck in the recess, which is in the form of a worm, to be created in the jaw bone. In addition to this, it is possible to provide for the tool additionally to carry out an axial movement, whose direction is reversed at short intervals, during the helical movement. This additional movement corresponds to the axial movement of a hammer chisel or a hammer drill, and should be extremely small, and in particular this interval-like axial movement path should be only a small fraction of the mean thickness of a worm thread, that is to say in general it should be in the region of tenths of millimeters to millimeters.

The invention also relates to an apparatus for carrying out a method for production of a recess, in the form of a screw, in the jaw bone for holding an anchoring part, in the form of a screw, of a jaw implant, in particular in the form of a worm.

A special apparatus is proposed to produce the recess in the form of a worm in the jaw bone. This comprises a tool with an essentially round core and at least one worm thread or partial worm thread integrally formed on it, with the size ratio of the external diameter to the core diameter of the tool being equal to or greater than 2, preferably between 2 and 5.

The external diameter of the worm thread or partial worm thread can change, at its lower end over an at least approximately radial curve, to the core diameter, and the curve can be provided with a material-removing apparatus. Intrinsically, this may be an expedient material-removing apparatus of virtually any desired type. For sake of simplicity, it is possible for the material-removing apparatus to comprise a number of teeth which are arranged one behind the other and remove material. Teeth such as these may be fitted such that they project radially and/or axially out of the curve, and may act as sawteeth, chisels or drill bits. They are of such a size and are arranged such that the worm thread to be produced is produced with the required shape and size. In this case, care should be taken to ensure that the dimensions of the worm thread together with the teeth of the apparatus are chosen to match the dimensions of the respective worm thread of the jaw implant to be held. This means that the recess in the form of a worm in the jaw should hold the worm thread of the jaw implant at least with a slight, in particular axial, pressure, in order that the worm thread can grow quickly and well with the jaw bone.

An abovementioned apparatus may comprise a mechanical device which is connected between the tool and a rotating shaft and converts the rotary movement of the shaft to the helical movement over the required angle, and possibly also to the axially intermittent movement, of the tool.

Further special advantages will also become evident to a person skilled in the art from the following description in conjunction with the drawing, in which exemplary embodiments of the invention are illustrated schematically.

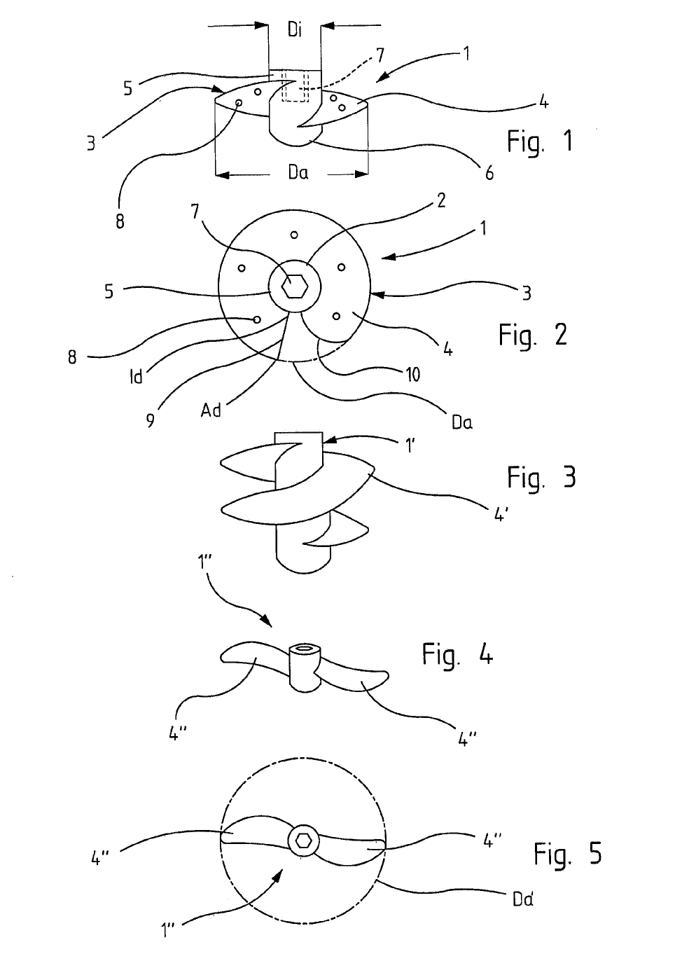

FIG. 1 shows a side view of a single-thread embodiment of a jaw implant with virtually one revolution.

FIG. 2 shows a plan view of the jaw implant shown in FIG. 1.

FIG. 3 shows a side view of a single-thread embodiment of a jaw implant with two revolutions.

FIG. 4 shows a side view of a two-thread embodiment of a jaw implant and a propeller-like shape with two blades.

FIG. 5 shows a plan view of the jaw implant shown in FIG. 4, with the external diameter indicated by dashed-dotted lines.

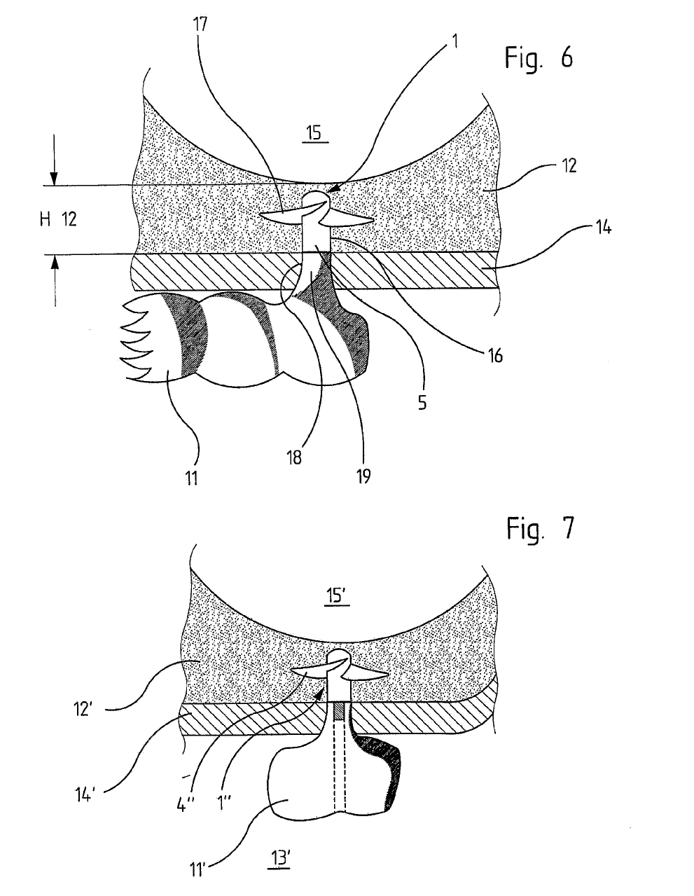

FIG. 6 shows a section view of how a dental prosthesis is mounted in the upper jaw by a single-thread worm.

FIG. 7 shows a section view of how a two-thread worm of a further dental prosthesis is mounted in the upper jaw.

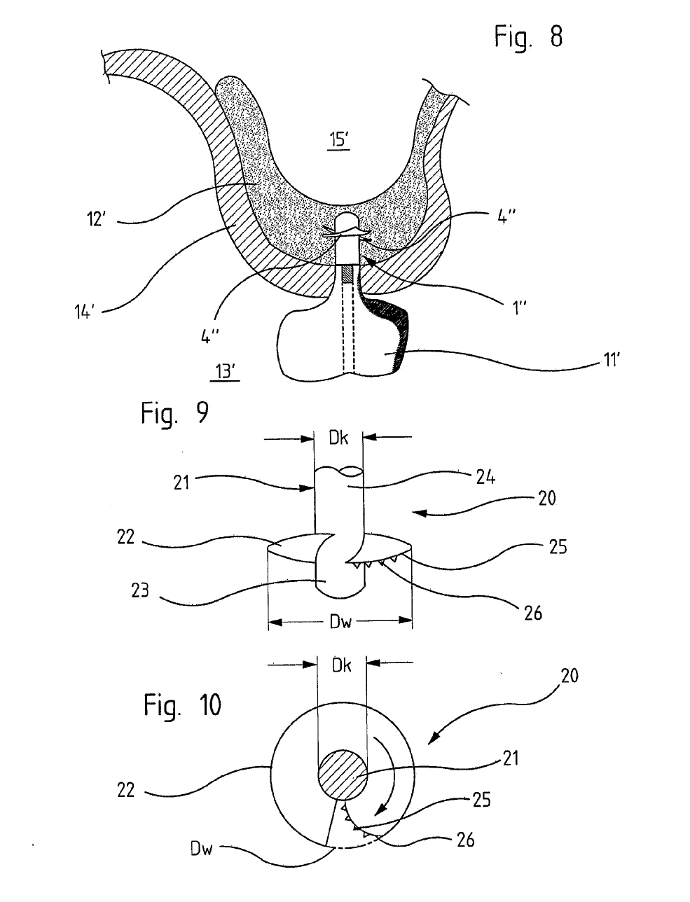

FIG. 8 shows a section view of the mounting shown in FIG. 7, transversely with respect to the plane of the section in FIG. 7.

FIG. 9 shows a side view of a tool for production of a recess, in the form of a worm, in the jaw in order to hold a jaw implant as shown in FIG. 1 and FIG. 2.

FIG. 10 shows a plan view of the tool shown in FIG. 9.

FIG. 1 schematically illustrates a side view of a jaw implant. This comprises an anchoring part 1, in the form of a screw, comprising a core 2 with a round cross section and a thread pitch integrally formed on it, in the form of a worm 3. The worm thread 4 has a cross section in the form of a very flat V-shaped thread, whose tip is slightly rounded. The constant external diameter Da is about 10 mm, the internal or core diameter Di is about 4 mm, and the length is about 5 mm. The core 2 projects somewhat beyond the worm thread 4 axially at the top and bottom, ending as an annular connecting stub 5 at the top and as a rounded area 6 in the form of part of a sphere at the bottom. An opening 7 like a blind hole is incorporated in the interior of the core 2, and the annular connecting stub 5 extends around it. The opening 7 is designed such that its unobstructed cross section is suitable for fitting of a turning tool, for example an Allen key or a polygonal internal key. At the core 2, the worm thread 2 has an inner thickness Id of about 1 mm, and on the rounded area has an outer thickness Ad of about 0.3 mm, that is to say on average about 0.6 mm. The flat worm thread 4 is provided with a number of axially continuous recesses 8.

FIG. 2 shows a plan view of the jaw implant from FIG. 1. This shows particularly clearly that the worm thread 4 covers somewhat less than one entire revolution. The external diameter Da has been added, in the form of a dashed-dotted line. While the upper end of the worm thread 4 ends with a straight radial edge 9 between the internal diameter Di and the external diameter Da, at least the lower end is provided with a curve 10 which extends virtually radially continuously from the internal diameter Di to the external diameter Da. In this case, the ratio of Da to Di is about 2.5.

FIG. 3 shows a side view of a single-thread embodiment of a jaw implant 1′ with two revolutions of a worm thread 4′. Otherwise, the jaw implant 1′ can be designed in the same way as the jaw implant 1 described with reference to FIG. 1, so that there is no need to describe this again.

FIG. 4 shows a side view of a jaw implant with a two-thread embodiment of the anchoring part 1″, and with a shape like a two-bladed propeller. FIG. 5 shows a plan view of this anchoring part 1″ with the external diameter Da″ indicated by dashed-dotted lines. This shows particularly clearly that two short worm threads 4″ which are arranged diametrically opposite at the same axial height cover only a fraction of one revolution and, in consequence, require only a short and extremely narrow bone area in the jaw for anchorage. The other features correspond to the embodiment described with reference to FIG. 1.

FIG. 6 shows a dental prosthesis 11 being mounted in the upper jaw bone 12 with the aid of an anchoring part 1, as has been described in more detail with reference to FIGS. 1 and 2, that is to say with a single-thread worm. This clearly shows that the anchoring part 1 requires only a relatively short bone area with the height H12 between the mouth cavity 13 with the gum 14 and the upper maxillary sinus 15, since the length of the anchoring part 1 is in this case only about 5 mm. In order to hold the anchoring part 1, a cylindrical hole 16 is introduced in a first step, and a helical recess 17, in the form of a worm, is introduced around the hole 16 in a second step. The anchoring part 1 was screwed into the combined opening, in the form of a worm, prepared in this way, until the illustrated position was reached. The anchoring part 1 virtually entirely fills the hole 16 and the recess 17, and the annular connecting stub 5, which has a small diameter, ends flush with the jaw bone 12, thus resulting in only a small circular opening 18 in the gum 14 around the neck 19 of the dental prosthesis 11.

FIGS. 7 and 8 show, in the form of a section, the fitting of a further dental prosthesis 11′, for example a crown, in the upper jaw bone 12, but with a two-thread worm. In this case, the anchoring part as described in more detail with reference to FIGS. 4 and 5 is used as the anchoring part 1″. Since the two partial worm threads 4″ are located at the same axial height and cover only a fraction of the circumference, this results in a particularly narrow and low physical height so that only a very short, and in particular also very narrow, bone area is required for anchorage in the upper jaw bone 12′.

FIG. 9 shows a plan view of a tool 20 for production of a recess in the form of a worm in the jaw bone, in order to hold a jaw implant as shown in FIG. 1 and FIG. 2. In principle, the tool 20 is designed to be similar to the anchoring part 1, and also to be largely matched to its dimensions, as mentioned above, except for the length. It comprises a round core 21 and a flat worm thread 22 which is integrally formed in a helical shape on it. The external diameter Dw of the worm thread 22 is at least twice as great as the core diameter Dk. The core 21 projects downwards with a rounded section 23 axially somewhat beyond the worm thread 22. The core 21 continues axially upwards with a section 24 beyond the worm thread 22.

The shape of the tool 20 can be seen better in the plan view in FIG. 10. The external diameter Dw of the tool 20 corresponds approximately to the diameter Da in FIG. 1, and the core diameter Dk corresponds approximately to the diameter Di in FIG. 1. The lower end of the worm thread 22 is provided with a curve 25, which extends virtually radially continuously from the core diameter Dk to the external diameter Dw. In this case, analogously to the corresponding ratio in FIG. 1, the ratio of Dw to Dk is approximately 2.5. The curve 25 is provided with a row of teeth 26 which are arranged one behind the other and project at least to the side radially somewhat from the curve 25, in the form of sawteeth. The teeth 26 can either be machined out of the material of the curve 25 or of the worm thread 22, or can be designed and arranged and attached to the curve 25 using a technique with which a person skilled in the art will be familiar, for example from saws, drills or mills fitted with hard metal. Their arrangement is intended to lead to the teeth being located only within the external diameter Dw of the tool 20, so that the recess, in the form of a worm, produced in this way, thus has virtually the same external diameter.

The tool 20 is used to produce a recess in the form of a worm in the jaw bone. For this purpose, in a first step, a suitable tool such as a drill, mill or the like is used to produce a short blind hole. Then, in a second step, the abovementioned tool 20 is used to introduce a recess in the form of a worm around the blind hole. In this case, the blind hole acts as a reliable guide for the lower core area 23 of the tool 20.

However, if the intention is to introduce a jaw implant with a two-thread, two-blade form, for example an anchoring part 1″ as shown in FIGS. 4 and 5, then the tool must be designed with a shape for the purposes of and similar to the jaw implant 1″. The teeth are then arranged on the curves of the two blades, and the tool covers only a portion of the circumference during the production of the recesses in the form of worms, thus resulting in only two short recesses in the form of partial helixes in the helix direction.

The tool 20 may be a component of an apparatus which has a rotating shaft. An apparatus which converts the rotary movement to a helical movement with a predetermined linear movement can be connected between the shaft and the tool 20. In addition, it is possible to provide the apparatus such that the helical movement direction is briefly and intermittently reversed during the helical forward movement of the tool 20. With an appropriate configuration and arrangement of the teeth, it is also additionally possible to provide for the axial movement component to be reversed intermittently. This last movement is similar to that of a hammer drill apparatus. The movement distances of the said intermittent movements of the tool 20 must be closely constrained, in order to ensure that the recess in the form of a worm that is produced is of the desired size, and are in the range from a few tenths of a millimeter to a few millimeters.

The abovementioned apparatus for driving the tool 20 can also be used to screw in the anchoring part of the jaw implant, in which case particular attention should be given to restricting the depth through which it is screwed in. In this application of the apparatus, the said optional intermittent movements must be switched off.

### REFERENCE SYMBOLS

1 Anchoring part
1′ Anchoring part
1″ Anchoring part
2 Core
3 Worm
4 Worm thread
4′ Worm thread
4″ Worm thread
5 Annular connecting stub
6 Rounded area
7 Opening
8 Recess
9 Edge
10 Curve
11 Dental prosthesis
11′ Dental prosthesis
12 Upper jaw bone
12′ Upper jaw bone
13 Mouth cavity
13′ Mouth cavity
14 Gum
14′ Gum
15 Upper maxillary sinus
15′ Upper maxillary sinus
16 Cylindrical hole
17 Recess in the form of a worm
18 Opening
19 Neck
20 Tool
21 Core
22 Worm thread
23 Section
24 Section
25 Curve
26 Tooth
Ad Outer thickness
Da External diameter
Da″ External diameter
Di Internal diameter
Dk Core diameter
Dw External diameter
Id Inner thickness
H12 Bone height

1. A jaw implant having an anchoring part (1; 1′; 1″) which is in the form of a screw and comprises a core (2) and at least one thread pitch (4; 4′; 4″) which is integrally formed radially on the core (2), characterized in that the anchoring part (1; 1′; 1″) is in the form of a worm (3) in which the size ratio of the external diameter (Da) to the core diameter (Di) is equal to or greater than 2.

2. The jaw implant as claimed in claim 1, characterized in that the size ratio is between 2 and 5.

3. The jaw implant as claimed in claim 1 or 2, characterized in that the worm thread (4) changes, at the lower end over an at least approximately radial curve (10), from the external diameter (Da) to the core diameter (Di).

4. The jaw implant as claimed in one of claims 1 to 3, characterized in that the core (2) has a circular-cylindrical cross section, has a section (6) which is rounded at the end and projects somewhat out of the worm (3) at the bottom, and has an annular connecting stub (5) which projects somewhat out of the worm (3) at the top.

5. The jaw implant as claimed in one of claims 1 to 4, characterized in that the external diameter (Da) remains at least essentially constant over the length of the worm thread (4).

6. The jaw implant as claimed in one of claims 1 to 5, characterized in that the worm thread (4) is designed in principle in the form of a very flat V-shaped thread.

7. The jaw implant as claimed in one of claims 1 to 5, characterized in that the worm thread is designed in principle in the form of a very flat trapezoidal thread or sawtooth thread.

8. The jaw implant as claimed in claim 6 or 7, characterized in that the outer tip or outer edge of the worm thread (4) is at least slightly rounded.

9. The jaw implant as claimed in one of claims 1 to 8, characterized in that the inner thickness (Id) of the worm thread (4) is 0.5 to 2.0 mm.

10. The jaw implant as claimed in one of claims 1 to 9, characterized in that the outer thickness (Ad) of the worm thread (4) is at most 1.0 mm.

11. The jaw implant as claimed in one of claims 1 to 10, characterized in that the worm thread (4; 4′) covers one entire revolution, or more than one entire revolution.

12. The jaw implant as claimed in one of claims 1 to 10, characterized in that the worm thread (4″) covers only a fraction of one revolution.

13. The jaw implant as claimed in one of claims 1 to 12, characterized in that the worm has two or more threads.

14. The jaw implant as claimed in claim 13, characterized in that the worm has two threads and both worm threads are in the form of a propeller blade with just two diametrically opposite partial worm threads (4″).

15. The jaw implant as claimed in one of claims 1 to 14, characterized in that the core diameter (Di) is 2 to 5 mm.

16. The jaw implant as claimed in one of claims 1 to 15, characterized in that at least one worm thread (4) or partial worm thread is provided with at least one recess (8).

17. The jaw implant as claimed in claim 16, characterized in that the recess (8) passes axially through the worm thread (4).

18. The jaw implant as claimed in claim 16 or 17, characterized in that the recess is open radially.

19. A method for production of a recess, in the form of a screw, in the jaw bone in order to hold an anchoring part, in the form of a screw, of a jaw implant, designed in particular as claimed in one of claims 1 to 18, characterized in that, in a first step, a cylindrical hole (16) is introduced into the jaw bone (12) and, in a second step, at least one recess (17), which is at least in the form of a partial helix and is in the form of a worm, is introduced around the cylindrical hole (16).

20. The method as claimed in claim 19, characterized in that the cylindrical hole (16) and/or the recess (17) which is at least partially in the form of a helix and is in the form of a worm, are/is introduced by means of a material-removing tool (20).

21. The method as claimed in claim 20, characterized in that a helical movement is applied to the tool (20).

22. The method as claimed in claim 21, characterized in that the movement direction of the tool (20) is reversed at short intervals, and then continued, during the helical movement.

23. The method as claimed in claim 21 or 22, characterized in that the tool (20) additionally carries out an axial movement, whose direction is reversed at short intervals, during the helical movement.

24. The method as claimed in claim 23, characterized in that the interval-like axial movement path is only a fraction of the mean thickness of a worm thread (4; 4′; 4″).

25. An apparatus for carrying out the method as claimed in one of claims 19 to 24, characterized in that the apparatus comprises a tool (20) with an essentially round core (21) and at least one worm thread (22) or partial worm thread integrally formed on it, and in that the size ratio of the external diameter (Dw) to the core diameter (Dk) of the tool (20) is equal to or greater than 2.

26. The apparatus as claimed in claim 25, characterized in that the size ratio is between 2 and 5.

27. The apparatus as claimed in claim 25 or 26, characterized in that the external diameter (Dw) of the worm thread (22) or partial worm thread changes, at its lower end over an at least approximately radial curve (25) to the core diameter (Dk), and the curve (25) is provided with a material-removing apparatus (26).

28. The apparatus as claimed in claim 27, characterized in that the material-removing apparatus comprises a number of teeth (26) which are arranged one behind the other and remove material.

29. The apparatus as claimed in claim 28, characterized in that the teeth (26) are fitted such that they project radially and/or axially out of the curve (25).

30. An apparatus for carrying out the method as claimed in one of claims 19 to 24 using an apparatus as claimed in one of claims 25 to 29, characterized by a device which is connected between the tool (20) and a rotating shaft and converts the rotary movement of the shaft to the helical movement, and possibly also to the axially intermittent movement, of the tool (20).
